(19) United States
(12) Patent Application Publication
(10) Pub. No.: US 2016/0334246 A1
(43) Pub. Date: Nov. 17, 2016

(54) PHOTOELECTRIC SENSOR AND ITS MOUNTING

(71) Applicant: SICK, Inc., Minneapolis, MN (US)

(72) Inventors: Jarrod HAUPT, Minneapolis, MN (US); Chris SHEPHERD, Minneapolis, MN (US)

(21) Appl. No.: 14/710,268

(22) Filed: May 12, 2015

(51) Int. Cl. G01D 11/24

(52) U.S. Cl. CPC G01D 11/24

(57) ABSTRACT

The invention relates to a photoelectric sensor, in particular a light curtain, and its pivotable mounting. The light curtain has an explosion proof housing which is mounted via alignment brackets to a fixed installation in a pivotable manner for alignment. For this, the alignment bracket has two U-shaped members which are connected by a bolt.

### FIELD OF THE INVENTION

The invention relates to a photoelectric sensor, in particular a light curtain, and its pivotable mounting.

### DESCRIPTION OF RELATED PRIOR ART

Multi-beam photoelectric sensors disclosed in DE 102006053003 B4, DE 102011050896 A1 and US 2003/0106992 each include units of paired light emitters and photo detectors to span a protective plane, typically called a light curtain, of a desired size by using units of light emitters and photo detectors. Multi-beam photoelectric sensors of this type are widely used for prohibiting intrusion of any part of a worker's body or any other object into a prohibited Zone like a work area of a dangerous machine tool, press machine or the like.

These photoelectric sensors usually comprise two opposed housings to hold the paired light emitters and photo detectors. Each light emitter and photo detector must be aligned which means that the directions (optical axes) of each paired emitter and detector much match. To achieve this the light emitters and photodetectors are fixedly mounted in the housing in an aligned manner and the opposed housings are then aligned by special mounts which fix the housing to a fixed installation. These mounts are pivotable to a certain degree along one axes. Different of such mounting constructions are disclosed in DE 102006053003 B4, DE 102011050896 A1 and US 2003/0106992.

In certain applications photoelectric sensors of the initially named kind are also used in areas where an increased danger of explosion exists. The requirements which must be observed in this regard with respect to explosion protection are, as a rule, relatively high. U.S. Pat. No. 5,998,785 discloses an additional explosion proof housing for such a photoelectric sensor. The problem then is, that the prior art mounting can't be used for the explosion proof additional housing. The additional housing is much larger and heavier because it is usually designed to be as large as the largest light curtain in order to be able to house all variants of sizes. Further it has no special mounts which have a high mechanical load capacity and are alignable.

### OBJECT OF THE INVENTION

It is therefore an object of the invention to provide a photoelectric sensor in an explosion proof housing which can easily be aligned and easily be mounted to an installation while the mounts having enough stability.

### BRIEF DESCRIPTION OF THE INVENTION

According to the invention there is provided a light grid having
a first housing which houses light transmitters and/or light receivers and electronic components to drive the light transmitters and/or receivers,
a second housing which is explosion proof and houses the first housing in a fixed manner,
an alignment bracket to mount the second housing to a fixed installation in an aligned manner,
the alignment bracket comprises a first member of a U-shape with a base plate and two side walls orthogonal to the base plate and placed at a distance apart and having a wall thickness, the side walls having aligned openings, and with at least one first base plate fastening element for fixture of the base plate to the fixed installation,
the alignment bracket further comprises a second member of the same structure as the first member wherein the distance of the side walls is reduced or enlarged by twice the wall thickness and with at least one second base plate fastening element for fixture of the second housing to the base plate,
the alignment bracket further comprises a fixable bolt for the feedthrough through the openings of the first and second members in order to connect both members being pivotable relative to each other as long as the bolt is not tightened.

In a preferred embodiement the side walls of the alignment brackets have a symmetrical trapezoidal shape with the longer of the parallel sides being connected with the base plate. This makes larger pivoting angles possible.

In an embodiement the side walls of the member with the larger distance between the side walls comprises a threaded hole for fixture of the bolt being a headed screw. This measure makes it easy to align since for alignment it is necessary to loosen only one screw, align it and tighten the one screw again.

In another embodiement the alignment bracket comprises a bushing having a length which is equal to the distance between the side walls of the member with the smaller distance and the bushing is placed in alignment with the openings and receives the bolt. The bushing avoids deformation of the brackets when fixing the bolt by tightening the screw.

### BRIEF DESCRIPTION OF THE DRAWINGS

FIG. 1 shows a light curtain;

FIG. 2 an exploded view of an explosion proof housing, alignment brackets and a part of a fixed installation;

FIG. 3 an alignment bracket;

FIG. 4 the alignment bracket of FIG. 2 in an exploded assembly drawing;

FIG. 5 the two members of the alignment bracket.

### DESCRIPTION OF THE PREFERRED EMBODIMENT

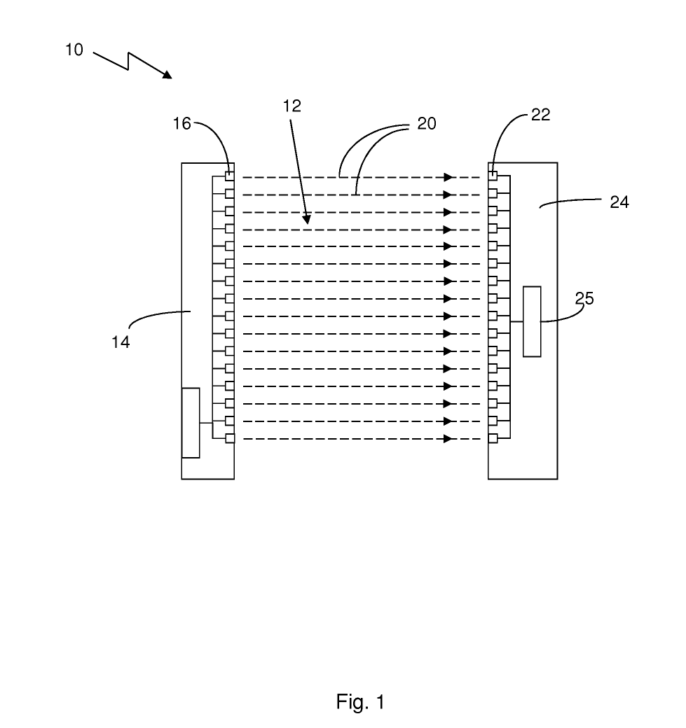

FIG. 1 shows a light curtain 10. The light curtain 10 comprises a first transmitter housing 14 and a first receiver housing 24. The first transmitter housing 14 houses light transmitters 16 and the first receiver housing 24 houses light receivers 22. Each light emitter 16 is paired with an opposed light receiver 22 so that light beams 20 form a light curtain 12. Evaluation units 25 evaluate the signals of the light recievers 22 and detect an interruption of a light beam 20.

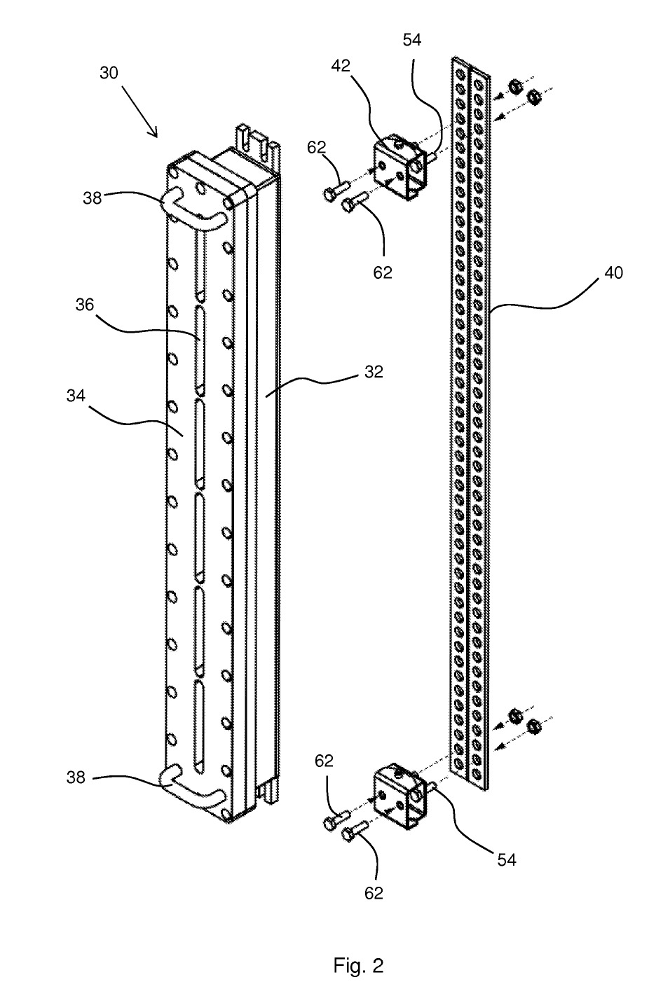

In an explosive environment the first housings must be housed in a second explosion proof housing. FIG. 2 shows such a second housing 30 which is explosion proof and which houses either one of the first housings 14 or 24. The first housing 14 or 24 is mounted inside the second housing 30 in a fixed manner, which means that its position inside the second housing 30 is fixed. The second housing 30 comprises a body 32 and front closure 34 transparent openings 36 for the light beams 20. Handles 38 are provided to handle the heavy second housing 30.

The second housing 30 can be mounted to a fixed installation 40 by means of at least one alignment bracket 42.

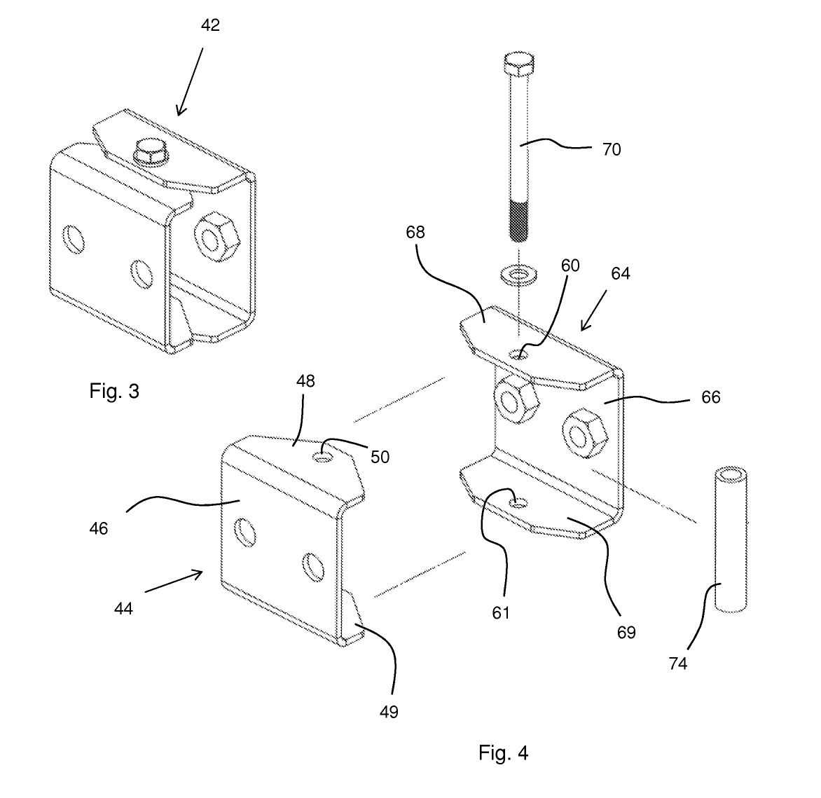

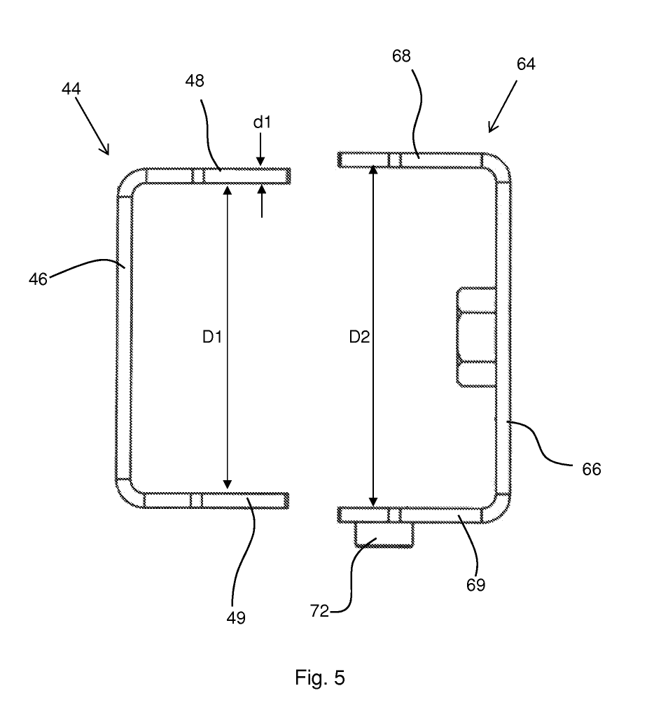

The alignment bracket 42 is shown in detail in FIGS. 3, 4 and 5 and comprises a first member 44 of a U-shape with a base plate 46 and two side walls 48 and 49 orthogonal to the base plate 46. The side walls 48 and 49 are placed at a distance D1 apart and have a wall thickness d1. The side walls 48 and 49 have aligned openings of which in the drawings only one (reference numeral 50) is visible. The side walls 48 and 49 have a symmetrical trapezoidal shape with the longer of the parallel sides being connected with the base plate 46.

The base plate 46 can be fixed to the installation 40 by at least one first base plate fastening element 54. This fastening element 54 can be a screw with a nut.

The alignment bracket further comprises a second member 64 of the same structure as the first member 44. It has a base plate 66 and side walls 68 and 69 of the same shape wherein the distance D2 of the side walls 68 and 69 is reduced or enlarged (in the figures it is enlarged) by twice the wall thickness d1 . The side walls 68 and 69 have aligned openings 60 and 61, preferably of the same size as the openings of the side walls 48 and 49 of the first member 44.

There is provided at least one second base plate fastening element 62 for fixture of the second housing 30 to the base plate 66.

The alignment bracket 42 further comprises a fixable bolt 70 for the feedthrough through the openings 50, 60 and 61 of the side walls 48 and 49 of the first member 44 and side walls 68 and 69 of the second member 64. The bolt 70 connects both members 44 and 64 together and leaves the members 44 and 64 pivotable relative to each other as long as the bolt 70 is not tightened. The bolt 70 is formed as a headed screw and can be screwed into opening 61 which has a thread realized by a nut 72 which is welded to side wall 69.

The alignment bracket further comprises a bushing 74 having a length which is equal to the distance D1 between the side walls 48 and 49 of the first member 44 with the smaller distance. The bushing 74 is placed in alignment with the openings 50, 60 and 61 and receives the bolt 70.

The two members 44 and 64 can be pivoted about an axes running through the bolt 70. In that way the second housing 30 and with it the light transmitters 16 or light receivers 22 within the housing can be aligned (angularly oriented), respectivley which leads to alignment of the light curtain 10.

1. Photoelectric sensor having
a first housing which houses light transmitters and/or light receivers and electronic components to drive the light transmitters and/or receivers,
a second housing which is explosion proof and houses the first housing in a fixed manner,
an alignment bracket to mount the second housing to a fixed installation in an aligned manner,
the alignment bracket comprises a first member of a U-shape with a base plate and two side walls orthogonal to the base plate and placed at a distance apart and having a wall thickness, the side walls having aligned openings, and with at least one first base plate fastening element for fixture of the base plate to the fixed installation,
the alignment bracket further comprises a second member of the same structure as the first member wherein the distance of the side walls is reduced or enlarged by twice the wall thickness and with at least one second base plate fastening element for fixture of the second housing to the base plate,
the alignment bracket further comprises a fixable bolt for the feedthrough through the openings of the first and second members in order to connect both members being pivotable relative to each other as long as the bolt is not tightened.

2. Sensor according to claim 1, wherein the side walls of the alignment brackets have a symmetrical trapezoidal shape with the longer of the parallel sides being connected with the base plate.

3. Sensor according to claim 1, wherein one of the side walls of the member with the larger distance between the side walls comprises a threaded hole for fixture of the bolt being a headed screw.

4. Sensor according to claim 3, wherein the alignment bracket comprises a bushing having a length which is equal to the distance between the side walls of the member with the smaller distance and the bushing is placed in alignment with the openings and receives the bolt.
